(19) United States
(12) Patent Application Publication
(10) Pub. No.: US 2004/0251341 A1
(43) Pub. Date: Dec. 16, 2004

(54) Left hand electric hydraulic control

(75) Inventors: Charles Lepage, Saskatoon (CA); Kimball Lischynski, Saskatoon (CA); Murray Kosokowsky, Pilger (CA)

Correspondence Address: DAVID R. PRICE, MICHAEL BEST & FRIEDRICH LLP, 100 EAST WISCONSIN AVENUE, MILWAUKEE, WI, 53202-4108, US

(73) Assignee: Highline Mfg. Inc., Saskatchewan (CA)

(21) Appl. No.: 10/865,010

(22) Filed: Jun. 10, 2004

(30) Foreign Application Priority Data
Jun. 13, 2003 (CA) 2,432,371

(51) Int. Cl. B02C 25/00

(52) U.S. Cl. 241/36

(57) ABSTRACT

A bale processor having a hydraulic motor driven bale manipulator is provided with a selector valve in the flow path of hydraulic fluid. The selector valve allows for the direction of hydraulic fluid flow to be controlled by a remote controller. Such a remote controller may be positioned on the left side of a tractor towing such a bale processor. In this way the operational discomfort of trying to reach hydraulic controls on the right side of the tractor while monitoring processing while observing from the left side of the tractor may be relieved.

### FIELD OF THE INVENTION

The present invention relates to bale processors for shredding bales and, more particularly, to an apparatus for controlling a hydraulic circuit on the processors from the left hand side of a tractor.

### BACKGROUND

In the livestock industry, large round and square bales are shredded to feed and bed livestock. One type of bale processor currently in the market includes a flail drum “disintegrator roller” longitudinally mounted for rotation inside a processing chamber. The flail drum is rotated, and flails on the drum extend to engage a bale supported above the drum in the processing chamber, shred the baled material and discharge the shredded material out of the processor. The processors include bale manipulators, generally in the form of bale rollers for rolling the bale within the processing chamber to expose different portions of the bale to the flails. The bale rollers are typically driven by hydraulic motors that allow the user to change the speed and direction of rotation of the rollers. Applicant's U.S. Pat. No. 5,340,040, issued Aug. 23, 1994 to Bussiere et al, discloses an early bale processor of the type described.

Typical bale processors of the type discussed are towed behind a tractor driven by an operator. A “Power Take-Off” (PTO) on the tractor provides a rotary force to rotate the disintegrator roller and a normally tractor-based hydraulic pump supplies hydraulic fluid to hydraulic motors that drive the bale rollers. Controls for the hydraulic pump and, thus, for the speed and direction of rotation of the bale rollers, are located in the cab of most tractors convenient to the operator's right hand, while the operator is facing forward. However, due to the design of the processors and the direction of rotation imparted by the PTO the shredded material is typically discharged from the bale processor on the left hand side, from the perspective of the forward-facing operator. Accordingly, the operator will normally tend to turn to the left to monitor the progress of the processing of a bale in the processor located behind the tractor. Manipulation of the hydraulic controls located on the right side of the tractor is inconvenient for the operator when turning to the left to monitor the processing.

One relief to this inconvenience is found in recently designed bale processors that discharge the shredded material out of the processor on the right hand side. As such, the operator may monitor the operation of the bale processor by turning to the right to be rearward-facing. In such a position, the hydraulic controls are readily accessible. However, in order to have right hand discharge in the types of processors being discussed, the disintegrator roller must be rotated in a direction opposite to the direction of rotation imparted to the disintegrator by the PTO. Therefore, a rotation conversion device is required for right hand discharge from bale processors of the type being discussed. Unfortunately, such rotation conversion devices are costly, may be subject to failure and may generally increase costs of maintenance and down-time for the machines. Further, in certain circumstances, there may be reasons why an operator prefers left-hand discharge.

### SUMMARY

Through the provision of a selector valve in the flow path of hydraulic fluid provided to a bale processor, the hydraulic fluid flow direction may be controlled by a remote controller. Such a remote controller may be positioned for easy access and ease of operability on the left side of a tractor. Advantageously, operational comfort is improved without requiring right hand discharge or rotation conversion, thus avoiding the problems that may be associated therewith.

In accordance with an aspect of the present invention there is provided a kit for providing control over direction of flow of hydraulic fluid in a hydraulic control circuit that drives at least one bale manipulator in a bale processor. The kit includes an electrical switch that may be conveniently actuated by an operator from the left side of a tractor cab, an electrically actuated hydraulic selector valve, under control of the electrical switch, adapted for placement in line with the hydraulic control circuit and electrical conductors for interconnection of the the electrical switch, selector valve and a power source.

In accordance with another aspect of the present invention there is provided a bale processor including a hydraulic control circuit for driving at least one bale manipulator of the bale processor. The bale processor includes an electrically actuated hydraulic valve placed in line with the hydraulic control circuit, the electrically actuated hydraulic valve controlling direction of flow of hydraulic fluid in the hydraulic control circuit and an electrical switch adapted to control the electrically actuated hydraulic valve, the electrical switch being mounted in the left side of a vehicle employed to tow the bale processor at a location such that the electrical switch may be conveniently manually operated by the operator of the bale processor.

In accordance with a further aspect of the present invention there is provided a bale processor including a hydraulic control circuit for driving at least one bale manipulator of the bale processor. The bale processor includes an electrically actuated hydraulic valve placed in line with the hydraulic control circuit, the electrically actuated hydraulic valve controlling direction of flow of hydraulic fluid in the hydraulic control circuit and an electrical switch adapted to control the electrically actuated hydraulic valve, the electrical switch being located in the left side of a vehicle employed to tow the bale processor such that the electrical switch may be conveniently grasped and held for convenient manual operation by the operator of the bale processor inside the cab of the tractor.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate an embodiment exemplary of the invention:

FIG. 1 is a perspective view of a bale processor including a selector valve according to an embodiment of the invention;

FIG. 2 is a perspective view of the selector valve of FIG. 1;

FIG. 3 is a perspective view of a remote controller for the selector valve of FIG. 2;

FIG. 4 is a perspective view of a housing for the remote controller of FIG. 3;

FIG. 5 illustrates a schematic representation of the hydraulic circuit in which the selector valve of FIG. 2 is employed according to an embodiment of the present invention, with the selector valve in a first mode of operation; and

FIG. 6 illustrates a schematic representation of the hydraulic circuit in which the selector valve of FIG. 2 is employed according to an embodiment of the present invention, with the selector valve in a second mode of operation.

### DETAILED DESCRIPTION

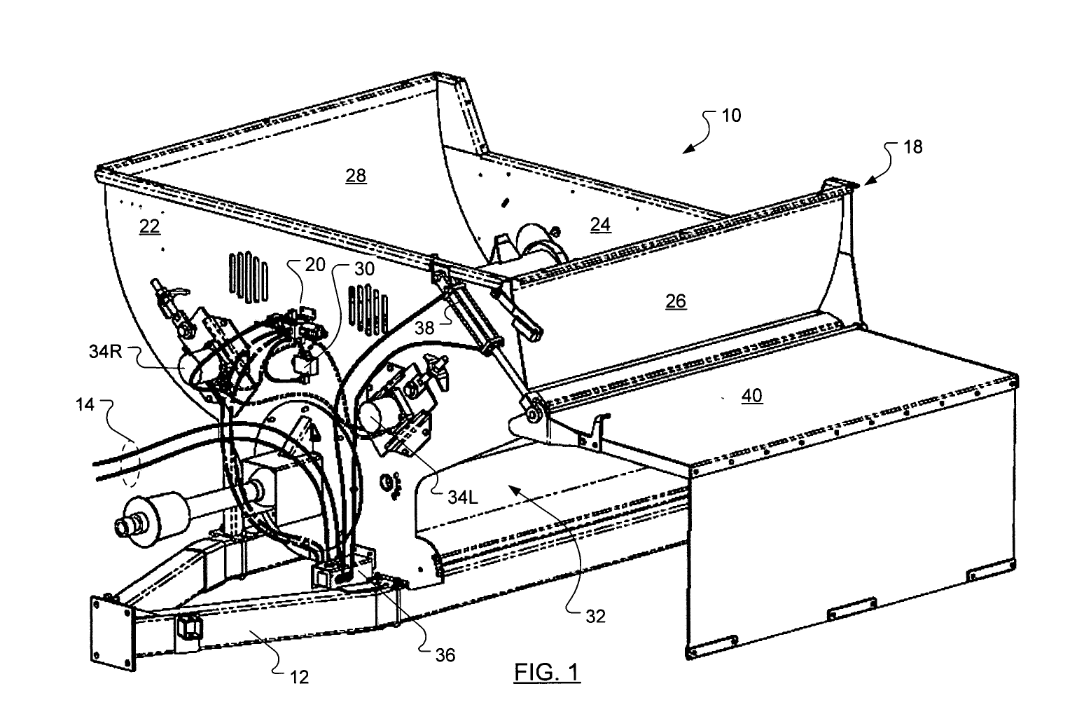

FIG. 1 illustrates an exemplary bale processor 10 showing an aspect of one embodiment of the present invention. The bale processor 10 has a frame structure 12 that supports a processing chamber 18 having a front end wall 22, a back end wall 24, a left side wall 26 and a right side wall 28. In the embodiment shown in FIG. 1, the left side wall 26 includes a left-hand side discharge opening 32 through which processed crop material may be discharged. The size of the discharge opening 32 may be adjusted through movement of an associated discharge door 40 controlled by hydraulic cylinder 38.

Two bale rollers (not shown) are mounted inside the processing chamber 18. A left hydraulic motor 34L and a right hydraulic motor 34R for turning the bale rollers are mounted to the front wall 22 of the bale processor 10. Also mounted to the front wall 22 are a selector valve 20, a splitter valve 30 and a mechanically actuated main distribution valve 36 for distributing the hydraulic fluid from the tractor-based hydraulic pump to drive the hydraulic motors 34L, 34R and the hydraulic cylinder 38. The main distribution valve 36 is in communication with a tractor hydraulic pump (not shown) via hydraulic lines 14.

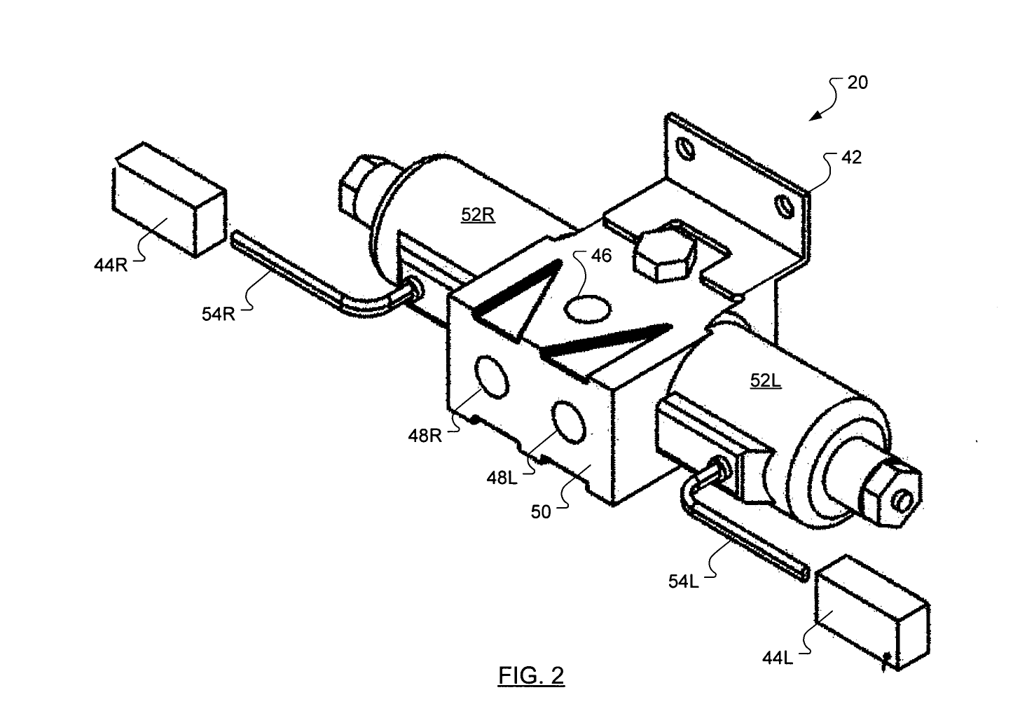

The selector valve 20 is illustrated in greater detail in FIG. 2. The selector valve 20 may be, for instance, a solenoid-operated selector valve such as the “Fluid Power MV4-42K-12LA” manufactured by Berendsen Fluid Power. A mounting plate 42 is attached to a body portion 50 of the valve 20 for securing the selector valve to the front wall 22. The body portion 50 includes pump connection ports on top 46 and bottom (not shown), and two motor connection ports 48L, 48R. Two housing extensions 52L, 52R extend laterally from the body portion 50 to house an internal solenoid (not shown). Extending from each of the housing extensions 52L, 52R is an electrical conductor 54L, 54R terminating in an electrical connector 44L, 44R.

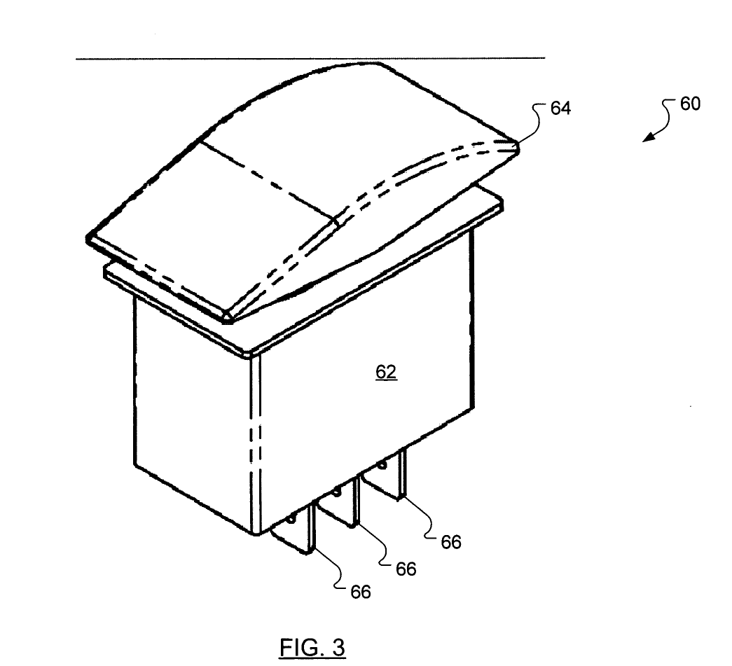

According to the present invention, the selector valve 20 is controlled remotely, i.e., at the location of the operator of the bale processor 10, which is typically, at the controls of the tractor towing the bale processor. As will be understood more fully after review of the following, the selector valve 20 may provide the bale rollers with three modes of operation: forward; reverse; and off. Accordingly, the remote controller may consist of a single pole double throw switch. An exemplary such “rocker” style electrical switch 60 is illustrated in FIG. 3 as having a base 62, a rocker 64 and electrical connections 66.

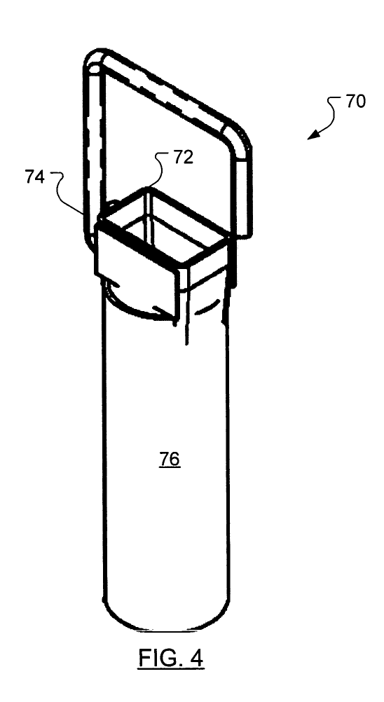

A mounting housing 70 for the electrical switch 60 is illustrated in FIG. 4. The electrical switch 60 may be fit into a steel frame 72 to which is attached a hook 74. The steel frame 72 may be housed within a shrink-fit tube handle 76 that acts to protect the electrical connections 66 and conductors and facilitates hand-held operation of the switch.

Electrical wires (not shown) are connected between the electrical connectors 44L, 44R on the selector valve 20 and two of the electrical connections 66 on the electrical switch 60. The switch 60 and selector valve 20 may be powered through the tractor battery with electrical wires connected between the battery, ground and the third electrical connection 66 on switch 60. As persons skilled in the art will understand, the required wiring may be accomplished in a number of ways. Alternatively, a wireless connection in conjunction with a separate power source may be utilized.

Advantageously, a control unit made up of the electrical switch 60 housed in the mounting housing 70 is adapted to fit easily and comfortably into a single hand and may be operated with that hand. The electrical switch 60 is preferably chosen to be durable and sized large enough to be used easily while the operator is wearing gloves or mitts. As the electrical switch 60 will be used in a outdoor environment, weather resistance is also important. Suitable switches have been determined to include part number v6das0b-azc from Carling Switch of Plainville, Conn. and part number m-58031-02 from Cole Hersee of Boston, Mass.

As will be understood by those skilled in the art, the switch 60 in the mounting housing 70 may be conveniently located to the left side of the tractor cab by hanging it using the hook 74 on any existing protrusion such as a window latch, or by mounting a hanging hook in the tractor cab at a convenient location for the operator to grasp it by the handle 76 for subsequent hand-held operation of the switch 60. Alternatively, the switch 60 in a mounting housing 70 may be mounted by any suitable fastener at a location to the left side of the tractor cab where the switch may be conveniently operated without removal from its mounted position while the operator is looking back to the left side of the processor. As will be understood by those skilled in the art wires used to connect the switch 60, selector valve 20 and tractor battery will be run in a conventional fashion so as to minimize inconvenience to the operator or interference with operation of the tractor or processor 10.

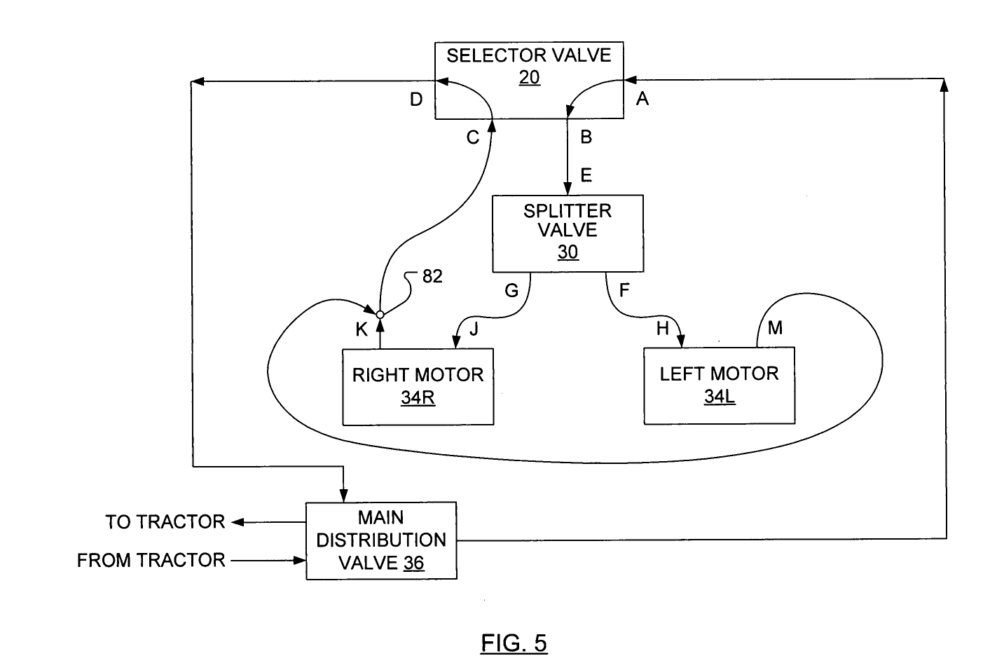

A schematic representation of a hydraulic circuit including the selector valve 20 in a first mode of operation is presented in FIG. 5. The ports of the selector valve 20 (and other elements of the hydraulic circuit) have been assigned reference letters to assist in the discussion of the operation of the hydraulic circuit. In particular, the top pump connection port 46 illustrated in FIG. 2 is referenced as “A” while the bottom pump connection port is referenced as “D”. The left motor connection port 48L is referenced as “B” and the right motor connection port 48R is referenced as “C”. It should be appreciated that FIG. 5 is limited to hydraulics and that an electrical connection (not shown) exists between the electrical switch 60 located in the tractor cab and the selector switch 20 mounted to the front wall 22 of the processing chamber 18.

Port B of the selector switch is connected to a port “E” of the splitter valve 30. Additional ports “G” and “F” of the splitter valve 30 are connected to a port “J” of the right motor 34R and a port “H” of the left motor 34L, respectively. A port “K” of the right motor 34R and a port “M” of the left motor 34L, respectively connect to the port C of the selector switch 20 via a T-junction 82.

In operation, baled crop material is loaded into the processing chamber 18 for disintegration. As discussed above, a disintegrator roller is adapted to disintegrate the baled crop material while the bale rollers manipulate the bale in the processing chamber 18 to expose different parts of the bale to the disintegrator roller.

During operation, as the disintegrator roller is rotated in a clockwise direction (viewed from the rear of the machine), flails extend radially to engage the baled crop material, separating the baled material from the bale and discharging the disintegrated material through the discharge opening 32. As the bale rollers are rotated in a clockwise direction (viewed from the rear of the machine), teeth on the bale rollers engage the bale contained within the processing chamber 18 to rotate the bale in a counter-clockwise direction (viewed from the rear of the machine), thereby exposing different sections of the bale to the flails for disintegration.

The bale processor operator, through the use of the electrical switch 60, may control the direction of flow of the hydraulic fluid through the hydraulic motors 34L, 34R that drive the bale rollers. By doing so, the operator may selectively cause the bale rollers to rotate in a clockwise direction, to stop or to rotate in a counterclockwise direction. Conveniently, the selection of direction may be made while the operator turns to the left to monitor the progress of the bale processing. The operator may, for instance, review the rate of shredded bale material being discharged through the discharge opening 32, consider the consistency of disintegration around the periphery of the bale or monitor loosening by reversal of rotation of the rollers of blockages due to frozen crop material or otherwise.

In the first mode of selector switch operation that is illustrated in FIG. 5, which may correspond, for instance, to clockwise rotation of the bale rollers, hydraulic fluid from the main distribution valve 36 is passed by the selector switch 20 from the port A to the port B. At the splitter valve 30, the hydraulic fluid is received at the port E and split between the port F, directed to the right motor 34R, and the port G, directed to the left motor 34L. At the right motor 34R, the hydraulic fluid is received at the port J and, after driving the right motor 34R to rotate the corresponding bale roller, is transmitted at the port K. Similarly, at the left motor 34L, the hydraulic fluid is received at the port H and, after driving the left motor 34L to rotate the corresponding bale roller, is transmitted at the port M. At the T-junction 82, the hydraulic fluid output from the port K of the right motor 34R and the port M of the left motor 34L is combined and transmitted to the port C of the selector switch 20. At the selector switch 20, the hydraulic fluid flows from the port C to the port D, where the fluid is transmitted back to the main distribution valve 36.

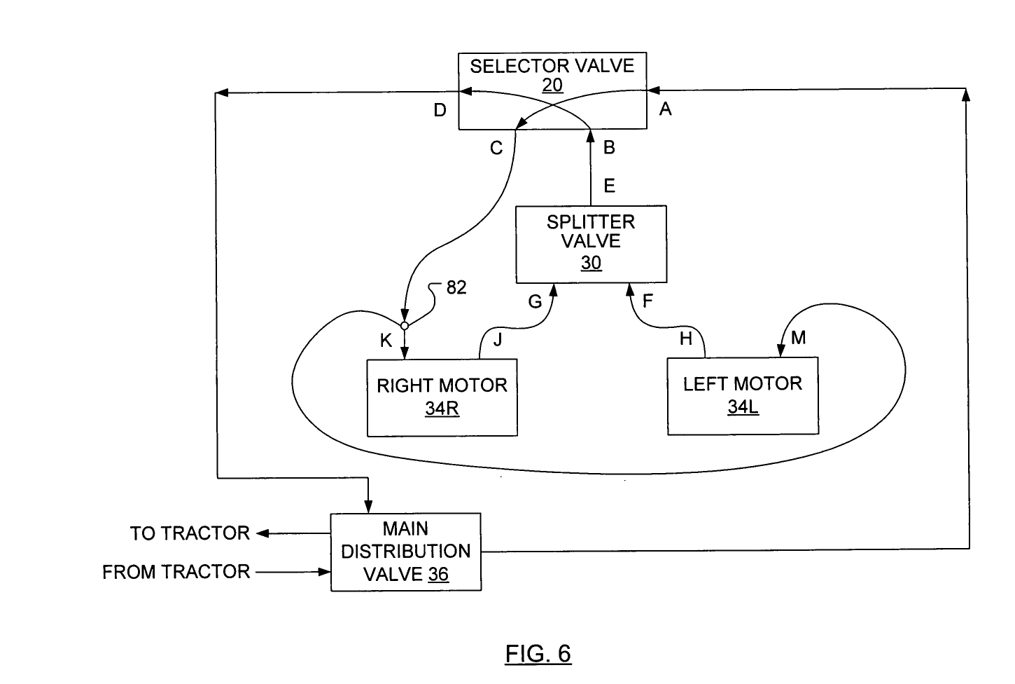

A second mode of selector switch operation is illustrated in FIG. 6. The second mode of selector switch operation may correspond, for instance, to counterclockwise rotation of the bale rollers, with hydraulic fluid from the main distribution valve 36 being passed by the selector switch 20 from the port A to the port C. At the T-junction 82, the hydraulic fluid is divided and sent to the port K of the right motor 34R and to the port M of the left motor 34L. At the right motor 34R, the hydraulic fluid is received at the port K and, after driving the right motor 34R to rotate the corresponding bale roller, is transmitted through the port J to port G on the splitter valve 30. Similarly, at the left motor 34L, the hydraulic fluid is received at the port M and, after driving the left motor 34L to rotate the corresponding bale roller, is transmitted through the port H to port F on the splitter valve 30. The hydraulic fluid received at the splitter valve 30 is combined and transmitted through the port E to the port B of the selector switch 20. At the selector switch 20, the hydraulic fluid flows from the port B to the port D, where the fluid is transmitted back to the main distribution valve 36.

As will be apparent to a person skilled in the art, at an intermediate position between the first mode of selector switch operation and the second mode of selector switch operation, there may be a third, “off”, mode of operation, in which the hydraulic fluid does not flow.

As will be also apparent to a person skilled in the art, in a conventional hydraulic circuit equivalent to the circuits of FIGS. 5 and 6, the supply from the main distribution valve 36 would be connected directly to the port E of the splitter valve 30 and the output of the T-junction 82 would be transmitted back to the main distribution valve 36. A change in direction of the bale rollers would be affected by reversing the flow of the hydraulic fluid supplied by the main distribution valve 36 through use of hydraulic controls located in the right side of the tractor cab. Such a reversal would mean that hydraulic fluid would be supplied to the T-junction 82 and would be transmitted from the port E of the splitter valve 30 back to the main distribution valve 36.

Advantageously, the electrical switch 60 may be chosen as having positions that correspond to the modes of operation of the selector switch 20. In particular, by way of example, it may be that when the rocker 64 of the electrical switch 60 is tilted to a forward position, the solenoids internal to the selector switch are actuated to a position that results in the flow illustrated in FIG. 5 and, consequently, clockwise rotation of the bale rollers. Furthermore, it may be that when the rocker 64 of the electrical switch 60 is tilted to a rearward position, the solenoids internal to the selector switch are actuated to a position that results in the flow illustrated in FIG. 6 and, consequently, counterclockwise rotation of the bale rollers. Additionally, a middle position of the rocker 64 of the electrical switch 60 may be arranged to correspond to the third, or “off”, mode of selector switch operation. Alternatively, the electric switch 60 may take the form of a two position switch, which may be used to switch bale roller rotation between forward and reverse, with the off mode being controlled at the conventional hydraulic controls.

Other modifications within the ambit of the following claims will be apparent to those skilled in the art and, the invention is accordingly defined by the claims.

We claim:

1. A kit for providing control over direction of flow of hydraulic fluid in a hydraulic control circuit that drives at least one bale manipulator in a bale processor, said kit comprising:
an electrical switch that may be conveniently actuated by an operator from the left side of a tractor cab;
an electrically actuated hydraulic selector valve, under control of said electrical switch, adapted for placement in line with said hydraulic control circuit; and
electrical conductors for interconnection of the said electrical switch, selector valve and a power source.

2. The kit of claim 1 wherein said direction of flow of hydraulic fluid corresponds to a direction of rotation of said bale manipulator and wherein said switch may actuate said hydraulic valve so as to cause rotation of said bale manipulator in a clockwise or in a counterclockwise direction.

3. The kit of claim 2 wherein said electrical switch may actuate said hydraulic valve so as to prevent the flow of hydraulic fluid in said hydraulic control circuit.

4. The kit of claim 1 wherein said electrical switch is contained in a housing having a handle and a hook.

5. A bale processor including a hydraulic control circuit for driving at least one bale manipulator of said bale processor, said bale processor including:
an electrically actuated hydraulic valve placed in line with said hydraulic control circuit, said electrically actuated hydraulic valve controlling direction of flow of hydraulic fluid in said hydraulic control circuit; and
an electrical switch adapted to control said electrically actuated hydraulic valve, said electrical switch being mounted in the left side of a vehicle employed to tow said bale processor at a location such that said electrical switch may be conveniently manually operated by the operator of the bale processor.

6. The bale processor of claim 5 wherein said direction of flow of hydraulic fluid corresponds to a direction of rotation of said bale manipulator and wherein said switch may actuate said hydraulic valve so as to cause rotation of said bale manipulator in a clockwise or counterclockwise direction.

7. A bale processor including a hydraulic control circuit for driving at least one bale manipulator of said bale processor, said bale processor including:
an electrically actuated hydraulic valve placed in line with said hydraulic control circuit, said electrically actuated hydraulic valve controlling direction of flow of hydraulic fluid in said hydraulic control circuit; and
an electrical switch adapted to control said electrically actuated hydraulic valve, said electrical switch being located in the left side of a vehicle employed to tow said bale processor such that said electrical switch may be conveniently grasped and held for convenient manual operation by the operator of the bale processor inside the cab of the tractor.

8. The bale processor of claim 7 wherein said direction of flow of hydraulic fluid corresponds to a direction of rotation of said bale manipulator and wherein said switch may actuate said hydraulic valve so as to cause rotation of said bale manipulator in a clockwise or counterclockwise direction.
